(19) United States
(12) Patent Application Publication
(10) Pub. No.: US 2022/0285864 A1
(43) Pub. Date: Sep. 8, 2022

(54) ELECTRICAL CONNECTOR ASSEMBLY

(71) Applicant: SIGNIFY HOLDING B.V., EINDHOVEN (NL)

(72) Inventor: PETER JOHANNES MARTINUS BUKKEMS, DEURNE (NL)

(21) Appl. No.: 17/630,239

(22) PCT Filed: Jul. 16, 2020
(86) PCT No.: PCT/EP2020/070213

§ 371 Date: Jan. 26, 2022

(30) Foreign Application Priority Data
Jul. 29, 2019 (EP) 19188879.1

(51) Int. Cl. H01R 12/70; H01R 13/639; G01D 11/24; G01D 11/30

(52) U.S. Cl. CPC H01R 12/7023; H01R 13/639; G01D 11/245; G01D 11/30; H01R 2201/04

(57) ABSTRACT

An electrical connector assembly (1) comprising a connector housing (5), a ceiling holder (3) and a cooling body (4), which ceiling holder (3) is provided between the connector housing (5) and the cooling body (4). The connector housing (5) comprises at least one clip lock mechanism (13, 14) with a resilient locking arm 15 which is provided with a first and a second clip (18, 19). Further the at least one clip lock mechanism (13, 14) comprises at least a first clip arm (21) which is provided with a first abutment protrusion (25) and a second abutment protrusion (26), respectively. The ceiling holder (3) may be manufactured of a number of materials, and depending of the chosen material, the thickness of the ceiling holder may differ. The connector housing (5) is adapted to be able to attach to ceiling holders of two different material thicknesses, in the first event, when the ceiling holder is manufactured of a thicker material thickness, the first and second clips (18, 19) engage with the ceiling holder (3), and in the second event, when the ceiling holder (3) is manufactured of a thicker material, at least one of the first and second abutment protrusions (25, 26) and the second clip (19) engage with the ceiling holder (3).

### FIELD OF THE INVENTION

The present invention relates generally to an electrical connector assembly according to the appended claims.

### BACKGROUND OF THE INVENTION

Internet connectivity has been extended to involve internet connectivity into physical devices such as for example lighting fixtures. Lighting fixtures for example used in ceilings may utilize and be connected to wireless sensor devices which may be wireless connected and in communication with wireless control devices and appliances. With such wireless control devices and appliances, e.g. these wireless sensor devices may be remotely controlled.

The wireless sensor devices may be attached to different lighting fixtures, which may be for example attached to ceilings. In one example the lighting fixtures comprises a sensor device attached to a ceiling mount which is fixedly attached to the ceiling. Further, the lighting fixture may also comprise a light source cooling body, provided behind the ceiling mount within an interior of the ceiling. The sensor device may be attached by means of clip mechanisms to the ceiling mount and to the light source cooling body.

The wireless sensor devices are further provided with circuit boards, preferably one first circuit board provided in the sensor device and one circuit board provided in the light source cooling body. The first and second circuit boards need to be in a fixed connection with each other, in order to transmit information from the sensor device to at least one light source within the lighting fixtures, thus different characteristics of the light source may be regulated.

The ceiling mount may be manufactured of a variety of different designs and materials. Depending of the design of the ceiling mount the material thickness may vary, and as a result of this also the design of the clip mechanisms of the sensor device and the design of the light source cooling body. Examples of such materials may be plastic or metal. In the case the ceiling holder is manufactured of a plastic material the material thickness of the ceiling holder is thicker compared to a ceiling holder manufactured of a metal material.

Thus, there is a need of two separate clip mechanisms to be provided, one embodiment for the case the ceiling mount is manufactured of a thin material, and one embodiment for the case the ceiling mount is manufactured of a thick material.

### SUMMARY OF INVENTION

An object of the present invention is to create an electrical connector assembly which facilitates assembly of different ceiling mounts comprising different material thicknesses and at the same time establishes a reliable connection between the different components.

According to a first aspect of the invention, there is provided a connector housing, comprising, an external surface, at least one clip lock mechanism is provided on said external surface, said at least one clip lock mechanism comprises a resilient locking arm. Said resilient locking arm is provided with a first clip and a second clip, both said first clip and said second clip protrude from said external surface of said connector housing and said first and second clips are provided at a distance from each other along a longitudinal extension direction of said connector housing. Further said at least one clip lock mechanism comprises at least one second clip mechanism provided on said external surface of said connector housing. Said at least one second clip mechanism comprises at least one first clip arm and said at least one first clip arm extend in said longitudinal extension direction of said housing. Further, said first at least one first clip arm is provided beside said resilient locking arm, and said at least one first clip arm is provided with a first abutment protrusion.

In a preferred embodiment said external surface comprises a first external surface and a second external surface which are parallel arranged in relation to each other, further said at least one clip lock mechanism comprises a first clip lock mechanism and a second clip lock mechanism, which first clip lock mechanism is provided on said first external surface and said second clip lock mechanism is provided on said second external surface.

In a preferred embodiment, said clip mechanism of said at least one clip lock mechanism comprises said first clip arm and a second clip arm, said first and second clip arms are provided one on each side of said resilient locking arm, further said second clip arm is provided with a second abutment protrusion.

In a preferred embodiment, said first clip comprises a first clip abutment surface and said second clip comprises a second clip abutment surface, said first and second clip abutment surfaces are parallel with and facing each other.

In a preferred embodiment, said first abutment protrusion is provided with a first abutment surface and said second abutment protrusion is provided with a second abutment surface, which first and second abutment surfaces are arranged on the same extension plane.

In a preferred embodiment, said first and second abutment surfaces may be parallel with said first and second clip arm abutment surfaces.

In a preferred embodiment, said first and second abutment surfaces may be angled in relation to said first and second clip arm abutment surfaces.

According to a second aspect of the invention, said electrical connector comprises a first circuit board provided with an alignment recess in a side edge of the first circuit board and further the electrical connector comprises said connector housing.

According to a third aspect of the invention, there is provided an electrical connector assembly comprising an electrical connector, a ceiling holder, a cooling body, wherein said ceiling holder is provided between said electrical connector and said cooling body.

In a preferred embodiment, said cooling body comprises a second housing, said second housing comprises at least an internal recess and an external abutment surface, further said ceiling holder comprises a ceiling holder abutment portion, wherein in an assembled state, either said first abutment protrusion is arranged to abut against said ceiling holder abutment portion together with said second clip which is arranged to abut against said internal recess or said first clip is arranged to abut against said ceiling holder abutment portion together with said second clip which is arranged to abut against said internal recess.

In a preferred embodiment, said cooling body comprises a locking part which is provided with a protruding flange, said protruding flange is arranged to hold said resilient locking arm in said internal, further said protruding flange is arranged to mesh with said alignment recess of said first circuit board.

These and other aspects of the invention will be apparent from and elucidated with reference to the embodiment(s) described hereinafter.

### BRIEF DESCRIPTION OF DRAWINGS

The invention is now described, by way of example, with reference to the accompanying drawings, in which:

FIG. 1 shows is an exploded perspective view of an electrical connector assembly in accordance with an embodiment of the invention,

FIG. 2 shows a perspective view of a connector housing in accordance with an embodiment of the invention,

FIG. 3 shows a view of an electrical connector in accordance with an embodiment of the invention,

FIG. 4 shows a section view according to section IV-IV of FIG. 3, and

FIG. 5 shows a section view according to section V-V of FIG. 3.

### DESCRIPTION OF EMBODIMENTS

In the description below, various directions may be given with reference to an electrical connector assembly when mounted in a ceiling. Examples of such may directions be up, down, internal, external etc. All examples herein should be seen as part of the general description and therefore possible to combine in any way in general terms. Again, individual features of the various embodiments may be combined or exchanged unless such combination or exchange is clearly contradictory to the overall function of the electrical connector assembly.

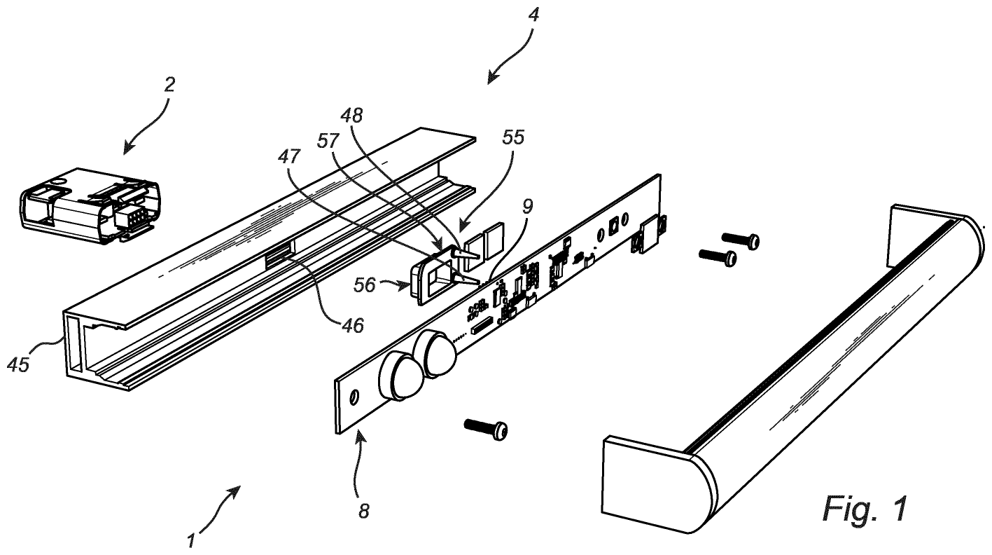

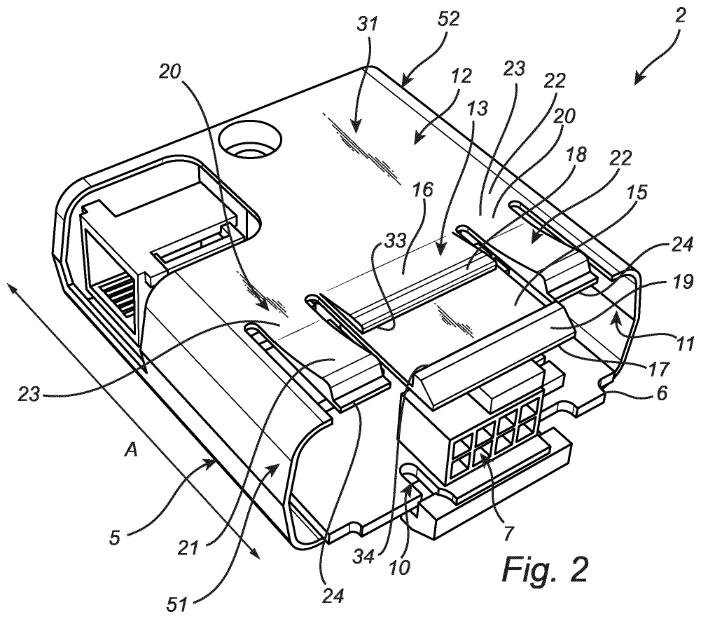

In the following, a detailed description of an electrical connector assembly according to the invention is given with reference to FIGS. 1-5.

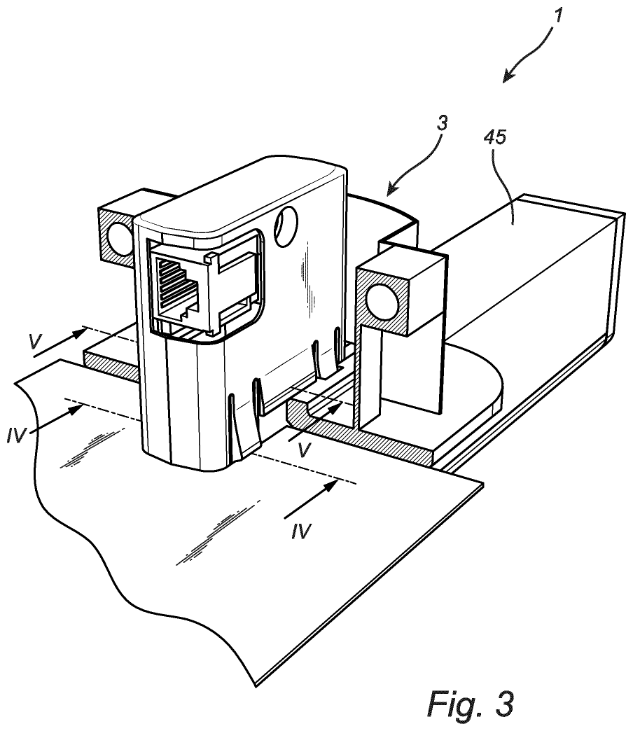

FIG. 1 shows an exploded perspective view of an electrical connector assembly 1 in accordance with an embodiment of the invention. The electrical connector assembly 1 comprises an electrical connector 2, a ceiling holder 3 (shown in FIG. 3) and a cooling body 4.

The electrical connector 2 comprises a connector housing 5 and first circuit board 6 provided with first connection terminals 7. Further, the cooling body 4 comprises a second circuit board 8 with second connection terminals 9, which in an assembled state of the electrical connector are in communication with the first connection terminals 7 of the first circuit board 6. The first circuit board 6 comprises an alignment recess 10 in a side edge of the first circuit board 6, which alignment recess 10 mesh with a locking part 55 to lock and align the first circuit board 6 with the second circuit board 8.

The connector housing 5 is shaped as a shell which comprises an internal surface 11 and an external surface 12. The connector housing 5 encloses at least a part of the first circuit board 6 and the first connection terminals 7. The external surface 12 is provided with at least a clip lock mechanism 13, 14, which is resilient and may deflect in a direction substantially perpendicular to the at least one external surface. The fact that the clip lock mechanism 13, 14 is resilient facilitates assembly of the electrical connector 2 and the cooling body 4. Thus, upon application of a pressure force acting on the clip lock mechanism 13, 14, in a direction towards the internal of the connector housing 5, the clip lock mechanism 13, 14 may deflect and when the pressure force is removed the clip lock mechanism may return to its original position. Said at least one clip lock mechanism 13, 14 comprises at least a resilient locking arm 15. The resilient locking arm 15 comprises a first end 16 attached to the connector housing 5 and a second end 17 which protrude from the connector housing 5 and is freely arranged, in a disassembled state. The resilient locking arm 15 is provided with a first clip 18 and a second clip 19. The first clip 18 is provided in the vicinity of the first end 16 of the resilient locking arm 15 and the second clip 19 is provided in the vicinity of the second end 17 of the resilient locking arm 15.

The first clip 18 and the second clip 19 of the resilient locking arm 15 are arranged to protrude from the external surface 12 of the connector housing 5. Further, the first and second clips 18, 19 are provided at a distance from each other, seen along a longitudinal extension direction A of the connector housing.

Further, the first clip 18 of the resilient locking arm 15 comprises a first clip abutment surface 33 and the second clip 19 comprise a second clip abutment surface 34. The first and second clip abutment surfaces 33, 34 are parallel with and facing each other.

The at least one clip lock mechanism 13, 14 comprises a clip mechanism 20, which is provided on the external surface 12 of the connector housing 5. The clip mechanism 20 may comprise at least one clip arm 21, 22. The clip mechanism 20 may comprise a first clip arm 21 and a second clip arm 22, which first and second clip arms 21, 22 extend in the longitudinal extension direction A. By using a first clip arm 21 and a second clip arm 22 a stable and balanced assembly is achieved, this due to that the arms 21, 22 are arranged to abut against the cooling body 4 at two abutment areas rather than only one single area of the connector housing 5. In conformity with the resilient locking arm 15, the first clip arm 21 comprises a first clip arm end 23 attached to the connector housing 5 and a second clip arm end 24 which is protrude from the housing 5 and is freely arranged in a disassembled state. In the same way the second clip arm 22 comprises a first clip arm end 23 attached to the connector housing 5 and a second clip arm end 24 which protrude from the housing 5 and is freely arranged in a disassembled state. The first clip arm 21 is provided with a first abutment protrusion 25 which protrude from the first clip arm end 23, and in the same way the second clip arm 22 is provided with a second abutment protrusion 26 which protrude from the second clip arm end 24. The first and second clip arm ends 23, 24 are arranged to be able to move freely towards and from the interior of the electrical connector 2, thus in a direction substantially perpendicular to the longitudinal extension direction A.

The first abutment protrusion 25 is provided with a first clip arm end abutment surface 27 and the second abutment protrusion 26 is provided with a second clip arm end abutment surface 28. Further, the first and second clip arm abutment surfaces 27, 28 are arranged on the same extension plane. In one embodiment the first and second clip arm abutment surfaces 27, 28 may be arranged to extend parallel with the first and second clip abutment surfaces 33, 34. In one embodiment the first and second clip abutment surfaces 27, 28 may be angled in relation to the first and second abutment surfaces 29, 30 such than an obtuse angular relation is provided. The first abutment protrusion 25 also comprises a first alignment surface 29, and the second abutment protrusion 26 comprises a second alignment surface 30. The first and second alignment surfaces 29, 30 may be perpendicular to the first and second clip arm end abutment surfaces 27, 28. Further, the first and second alignment surfaces 29, 30 are arranged in the same extension plane. Upon alignment of the connector housing 5 to the ceiling holder, the first and second alignment surfaces 29, 30 are provided to abut against the ceiling holder abutment portion 35, 54, this to fixate the electrical connector 2 in relation to the cooling body 4 and the ceiling holder 3.

Further, the resilient locking arm 15 and the first and second clip arms 21, 22 are arranged to extend in the same direction. The first clip arm 21 and the second clip arm 22 are provided one on either side of the resilient locking arm 15.

The external surface 12 of the connector housing 5 comprises a first external surface 31 and a second external surface 32 which are parallel and provided at a distance from each other. Further, the external surface 12 comprises a first external side surface 51 and a second external side surface 52, which extend between the first and second external surfaces 31, 32. The at least one clip lock mechanism 13, 14 may comprises a first clip lock mechanism 13 and a second clip lock mechanism 14. In one embodiment the first external surface 31 is provided with the first clip lock mechanism 13 and the second external surface 32 is provided with the second clip lock mechanism 14.

Further, the ceiling holder 3 may be arranged within a ceiling mount of e.g. a lamp fitting, which lamp fitting may be attached to a ceiling or a wall. Thus, the expression “ceiling holder” shall not be restricted to assemblies only fitted to ceilings, it may also be applicable to mountings fitted to walls or any other surface.

The ceiling holder 3 is arranged between the electrical connector 2 and the cooling body 4 and is kept in an assembled state by means of the at least one clip lock mechanism 13, 14 and the locking part 55. Further, the ceiling holder 13 is provided with a ceiling holder abutment portion 35 comprising a first ceiling holder surface 36 and a second ceiling holder surface 37. The first ceiling holder surface 36 is arranged to face the major part of the first and second external surfaces 31, 32 of the connector housing, within an assembled state, and the second ceiling holder surface 37 is facing the cooling body 4, within an assembled state.

The cooling body 4 comprises a second housing 38 which comprises a cooling body external surface 39 and a cooling body internal surface 40, which internal side 40 comprises at least one internal recess 41, 42, which, in an assembled state, is provided to abut with the second clip 19 of the resilient locking arm 15. In one embodiment, the at least one internal recess 41, 42 may be a first internal recess 41 and a second internal recess 42. The first and second internal recesses 41, 42 comprise first and second internal recess restricting surfaces 43, 44, which mesh with the second clips 19 of the resilient locking arms 15.

Further, the external surface 39 of the cooling body 4 comprises an external abutment surface 45, which, in an assembled state, is arranged to abut against the second ceiling holder surface 37 of the ceiling holder abutment portion 35. The cooling body 4 comprises an opening 46 which is provided in the external abutment surface 45 of the cooling body 4.

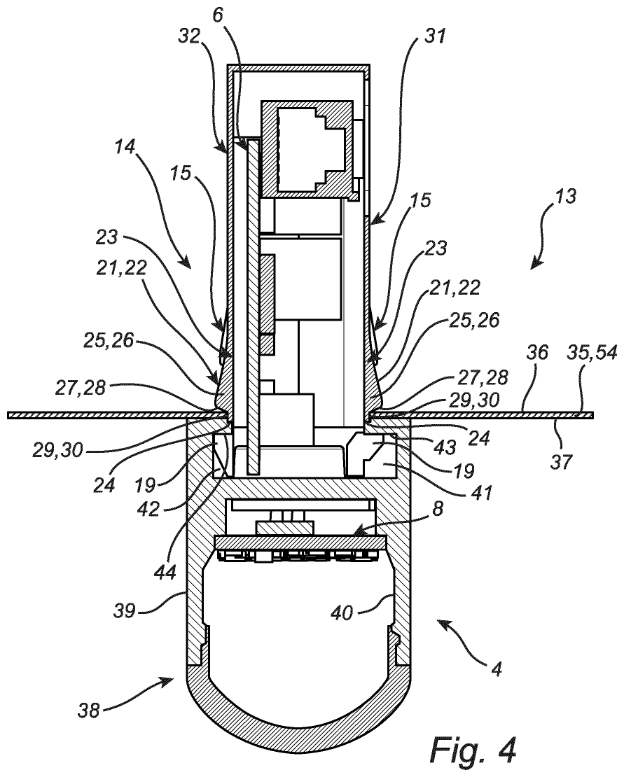

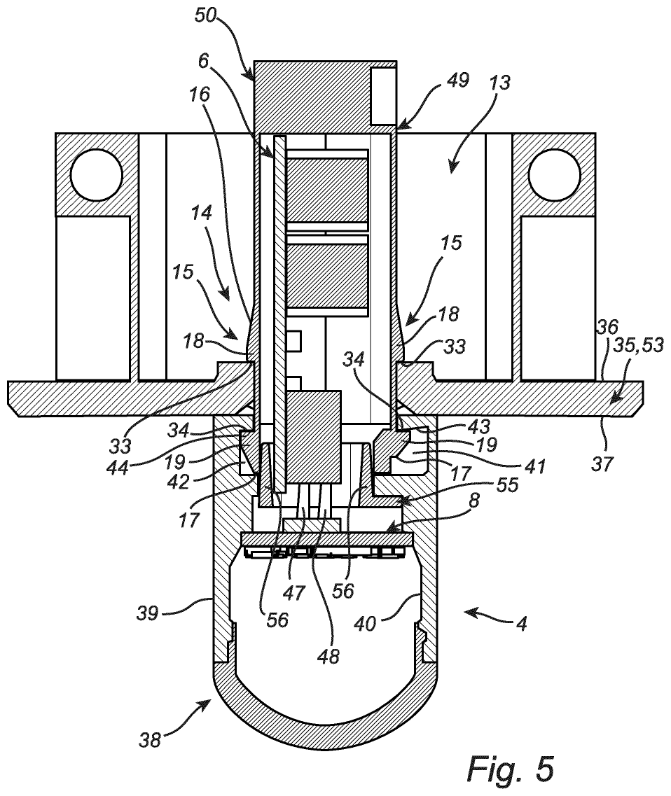

The ceiling holder abutment portion 35 is a protruding flange which protrude form at least a part of the circumference of the ceiling holder 3. The ceiling holder 3 may be manufactured in two different sets, one ceiling holder with a thick protruding flange 53 and one ceiling holder with a thinner protruding flange 54. In FIG. 5 it is shown a section view of the protruding flange 53 together with the ceiling holder 3, whereas FIG. 4 only shows the protruding flange 54 and not the remainder of the ceiling holder 3. In this context, when referring to the expressions “thin” and “thick”, this is relatively speaking when comparing the thicknesses of the protruding flanges 53, 54 with each other. The reason why the thicknesses of the protruding flanges 53, 54 differ, is due to that the ceiling holders 3 may be manufactured of different materials. In the case the ceiling holder 3 is manufactured of e.g. metal the abutment portion, due to strength purposes, does not need to be as thick as in a case when the ceiling holder 3 is manufactured of e.g. plastic.

In an embodiment, wherein the ceiling holder 3 is manufactured of e.g. plastic, and is provided with a thick protruding flange 53, relatively speaking, the first clip 18 is arranged to abut against said ceiling holder abutment portion 35 together with the second clip 19 which is arranged to abut against the internal recess 41, 42. More precisely, the first clip abutment surface 33 is arranged to abut against the first ceiling holder abutment surface 36 and the second clip holder surface 34 is arranged to abut or mesh with the internal recess 41, 42 of the cooling body 4.

In an embodiment, wherein the ceiling holder 3 is manufactured of e.g. metal, and is provided with a thin protruding flange 54, relatively speaking, the first abutment protrusion 25, 26 is arranged to abut against the ceiling holder abutment portion 35 together with the second clip 19 which is arranged to abut against the internal recess 41, 42. More precisely, the second clip holder surface 34 is arranged to abut or mesh with the internal recess 41, 42 of the cooling body 4 and the first clip arm end abutment surface 27 and the second clip arm end abutment surface 28 of the first and second clip arms 21, 22 are arranged to abut against the first ceiling holder abutment surface 36.

Through the opening 46 of the cooling body 4 the first and second clip lock mechanisms 13, 14 may protrude into the interior of the cooling body 4. The locking part 55 comprises a locking part flange 57 from which the protruding flange 56 extend in one direction and the protruding legs 47, 48 extend in the opposite direction. The protruding flange 56 extend around the circumferential of the locking part 55. The locking part 55 with its protruding flange 56, is mounted within the interior of the cooling body 4. In an assembled state, the protruding flange 56 is mounted within the opening 46 and the locking part flange 57 is arranged to abut with the internal surface 40 of the cooling body 4. Further, the protruding flange 56 is arranged to mesh with the alignment recess 10 of the first circuit board 6. The locking part 55 may comprise a first protruding leg 47 and a second protruding leg 48. The first and second protruding legs 47, 48 are parallelly arranged in relation to each other and are arranged to extend in the opposite direction as the protruding flange 56 of the locking part 56. The protruding flange 56 and the protruding legs 47, 48 extend in the same longitudinal extension direction. Thus, the protruding legs 47, 48 are arranged to abut against the second circuit board 8 and ensure that the locking part 55, in an assembled state, is held in place in the opening 46. The alignment recess 10 mesh with the protruding flange 56 of the locking part 55. Thus, by means of the alignment recess 10 the first circuit board 6 together with its first connection terminals 7 is be aligned with the cooling body 4 and the second connection terminals 9 of the second circuit board 8. This creates a firm connection between the components of the electrical connector assembly 1 and ensure a reliable signal transmission between the components.

In an assembled state, the protruding flange 56 is arranged to retain each one of the resilient locking arms 15 in the internal recesses 41, 42, thus preventing the second clips 19 of the resilient locking arms 15 from disengaging from the internal recess 41, 42 of the cooling body 4. This ensures that the first and second circuit boards 6, 8 establish contact and connect to each other in a reliably manner.

The electrical connector 2 may be a sensor device, light application device, e.g. a spot light, or any other transmitter or receiver.

Upon assembly of the electrical connector assembly 1, the cooling body 4 is provided with the second circuit board 8 together with its second connection terminals 9 and the locking part 55 is introduced into the opening 46. In another step the electrical connector housing 5 is provided with the first circuit board 6 together with the first connection terminals 7 and the connector housing 5 is connected to the cooling body 4, by introducing the resilient locking arms 15 into the opening 46, where after the second clip 19 is deflected so that it is able to abut into the internal recess 41. When, second clip 19 abuts into the internal recess 41, 42, the second clip is restrained from disengaging by means of the protruding flange 56 of the locking part 55. In another step the ceiling holder 3 is mounted onto the connector housing 5, wherein either the first clip arm end abutment surface 33, is arranged to abut against the first ceiling holder abutment surface 36 of said ceiling holder 3 together with the second clip arm end abutment surface 34 which is arranged to abut against the internal recess 41, 42, this is the case when the ceiling holder abutment portion is of a “thick” material thickness, relatively speaking. In the case the ceiling holder is of a “thin” material thickness, relatively speaking, both the first alignment surface 29 and the second alignment surface 30 together with the first and second clip arm end abutment surfaces 27, 28 are arranged to abut against the ceiling holder abutment portion 35 together with the second clip arm end abutment surface 34 is arranged to abut against the internal recess 41, 42.

While the invention has been illustrated and described in detail in the drawings and foregoing description, such illustration and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

1. An electrical connector assembly, comprising:
a connector housing, comprising,
an external surface,
at least one clip lock mechanism is provided on said external surface,
said at least one clip lock mechanism comprises a resilient locking arm,
said resilient locking arm is provided with a first clip and a second clip,
both said first clip and said second clip protrude from said external surface of said connector housing, and said first and second clips are provided at a distance from each other along a longitudinal extension direction of said connector housing,
further said at least one clip lock mechanism comprises at least one clip mechanism provided on said external surface of said connector housing, said at least one clip mechanism comprises at least one first clip arm, said at least first clip arm extend in said longitudinal extension direction of said connector housing, and said at least one first clip arm is provided beside said resilient locking arm, said at least one first clip arm is provided with a first abutment protrusion,
an electrical connector comprising a first circuit board provided with an alignment recess in a side edge of the first circuit board and further the electrical connector comprises said connector housing,
a cooling body,
a ceiling holder which is provided between said electrical connector and said cooling body.

2. The electrical connector assembly according to claim 1, wherein said external surface comprises a first external surface and a second external surface which are parallel arranged in relation to each other, further said at least one clip lock mechanism comprises a first clip lock mechanism and a second clip lock mechanism, which first clip lock mechanism is provided on said first external surface and said second clip lock mechanism is provided on said second external surface.

3. The electrical connector assembly according to claim 1, further said clip mechanism of said at least one clip lock mechanism comprises said first clip arm and a second clip arm, said first and second clip arms are provided one on each side of said resilient locking arm, further said second clip arm is provided with a second abutment protrusion.

4. The electrical connector assembly according to claim 1, wherein said first clip comprises a first clip abutment surface and said second clip comprises a second clip abutment surface, said first and second clip abutment surfaces are parallel with and facing each other.

5. The electrical connector assembly according to claim 4, wherein said first abutment protrusion is provided with a first abutment surface and said second abutment protrusion is provided with a second abutment surface, which first and second abutment surfaces are arranged on the same extension plane.

6. The electrical connector assembly according to claim 5, wherein said first and second abutment surfaces may be parallel with said first and second clip arm abutment surfaces.

7. The electrical connector assembly according to claim 1, wherein said cooling body comprises a second housing, said second housing comprises at least an internal recess and an external abutment surface, further said ceiling holder comprises a ceiling holder abutment portion, wherein
in an assembled state, either said first abutment protrusion is arranged to abut against said first ceiling holder abutment portion together with said second clip which is arranged to abut against said internal recess
or said first clip is arranged to abut against said first ceiling abutment portion together with said second clip which is arranged to abut against said internal recess.

8. The electrical connector assembly according to claim 1, further said cooling body comprises a locking part which is provided with a protruding flange, said protruding flange is arranged to hold said resilient locking arm in said internal recess, further said protruding flange is arranged to mesh with said alignment recess of said first circuit board.

9. The electrical connector assembly according to claim 1, wherein said electrical connector is a sensor device.

10. (canceled)
